(19) United States
(12) Patent Application Publication
(10) Pub. No.: US 2026/0349964 A1
(43) Pub. Date: Nov. 5, 2026

(54) COMPRESSION ACCELERATORS WITH HETEROGENEOUS HISTORY SIZES

(71) Applicant: Intel Products IP LLC, Santa Clara, CA (US)

(72) Inventors: James GUILFORD, Northborough, MA (US); Vinodh GOPAL, Westborough, MA (US); Daniel F. CUTTER, Maynard, MA (US)

(21) Appl. No.: 19/720,784

(22) Filed: Jun. 25, 2026

(51) Int. Cl. G06F 16/174

(52) U.S. Cl. CPC G06F 16/1744

(57) ABSTRACT

Compression accelerators with heterogeneous history sizes. An apparatus includes a plurality of compress cores and a plurality of decompress cores, including first decompress cores configured to perform decompression operations using a history buffer having a first size, and second decompress cores configured to perform decompression operations using a history buffer having a second size larger than the first size. The apparatus further includes routing and arbitration circuitry to assign compression operations to compression cores and assign decompression operations to the first decompress cores and the second decompress cores based on the history size used to compress data files and data streams to be decompressed. Routing also used AUTO directives that could be included in decompression and compression work descriptors.

### BACKGROUND INFORMATION

Compression is compute-intensive and benefits significantly from specialized hardware accelerators. LZ77 compressors, such as the popular DEFLATE algorithm, find matches between the current bytes and a previous occurrence in the input stream within a history window. If a match is not found, the data is represented as literals. Data is compressed as a result of finding matches since a match can be encoded compactly with a <length, relative backward-distance offset> pair, rather than all the literal bytes that it represents.

Better/longer matches result in better compression and larger history windows result in finding better overall matches as they examine a larger number of candidates. State-of-the-art LZ77-family hardware compressors/decompressors incur high silicon area cost because each compression/decompression core requires dedicated local memory proportional to its supported history size. While DEFLATE is defined with 32 KB history, newer algorithms like Snappy/LZ4 need 64 KB, and Zstandard requires 256 KB or larger.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a sliding window-based string match search scheme;

FIG. 2 is a graph depicted a distribution of matched string lengths vs. percentage of occurrences;

FIG. 3 is a flowchart illustrating operations and logic employed by a conventional LZ77 encoder;

FIG. 4 is a diagram illustrating encoding a character string using conventional LZ77 encoding;

FIGS. 5, 5a, 5b, 5c, and 5d show diagrams illustrating examples of compress/decompress accelerators including base engines, compress cores, and decompress cores, according to respective embodiments;

FIG. 6 is a flowchart illustrating operations and logic associated with use of AUTO_SIZE and AUTO_PERF flags;

FIG. 7a is a schematic diagram of a platform architecture including a processor having an on-chip accelerator configured to implement accelerator state operations in accordance with one or more embodiments disclosed herein;

FIG. 7b is a schematic diagram of a variant of the platform architecture of FIG. 7a under which the processor and accelerator are separate components;

FIG. 7c is a schematic diagram of a variant of the platform architecture of FIG. 7b under which the accelerator includes a memory controller and is enabled to directly write to and read from memory.

FIG. 8 is schematic diagram illustrating an exemplary implementation system including a cloud-hosted service the serves various clients via the Internet and under which embodiments of the match sharing scheme in hardware compression accelerators may be implemented;

FIG. 9a is a frontal isometric view of an exemplary blade server chassis in which a plurality of server blades are installed;

FIG. 9b is a rear isometric view of the blade server chassis of FIG. 14a;

FIG. 9c is an isometric frontal view of an exemplary blade server rack in which a plurality of rack-mounted blade server chassis corresponding to FIGS. 16a and 16b are installed; and

FIG. 10 shows details of the components of a typical server blade, according to one embodiment.

### DETAILED DESCRIPTION

Embodiments of compression accelerators with heterogeneous history sizes are described herein. In the following description, numerous specific details are set forth to provide a thorough understanding of embodiments disclosed herein. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

### LZ77 Compression and Decompression

LZ77 compression schemes find repeated substrings and replace them with backward references (relative distance offsets in the original stream). The compressed data comprises of a series of elements of two types: literal bytes and pointers to replicated strings, where a pointer is represented as a pair <length, backward distance offset in the uncompressed stream>. Entropy encoding (e.g. Huffman coding) utilizes variable length codes to represent symbols such that frequent symbols get short codes and infrequent symbols get long codes, thereby representing the set of symbols compactly.

The DEFLATE scheme uses a combination of LZ77 compression and Huffman encoding (entropy encoding) to encode a bitstream comprising a sequence of blocks. A block is preceded by a 3-bit header that identifies whether or not the block is the last block in the stream and the type of encoding method used for the block. Many or most blocks will end being encoded using dynamic Huffman encoding, while other blocks may store a literal or string between 0 and 65,535 bytes in length. Static Huffman encoding may also be used for some blocks.

Compression is achieved through two operations. The first operation comprises string matching and replacement of duplicate strings with pointers. The second operation comprises replacing symbols with new, weighted symbols based on frequency of use. Within compressed blocks, if a duplicate series of bytes (a repeated string) is detected, then a back-reference is inserted (referred to herein as a reference), linking to the previous location of that identical string instead. An encoded match to an earlier string consists of a length L (or Len) (3-258 bytes) and a distance D (1-32,768 bytes (32 KB)). Relative back-references can be made across any number of blocks, as long as the distance appears within the last 32 KB of uncompressed data decoded, which is referred to as the sliding window. Under another variant, a 64 KB window is used.

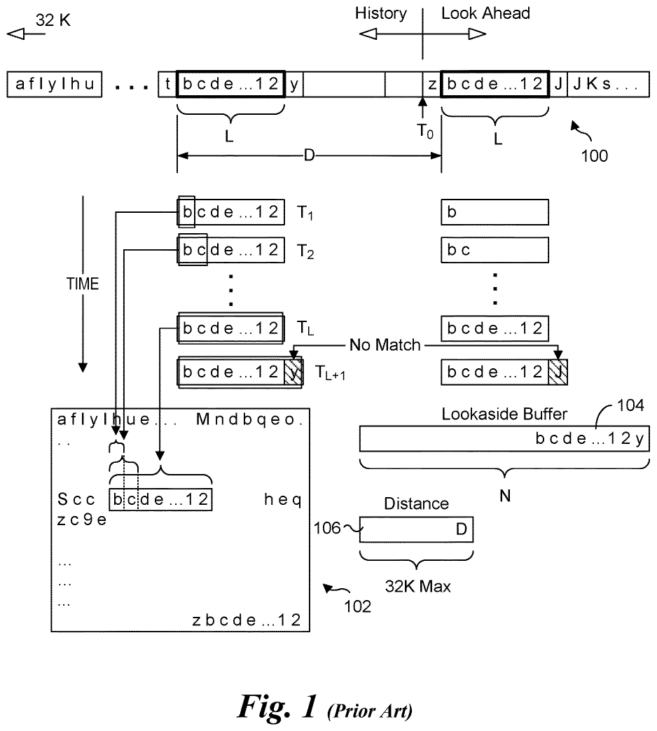

FIG. 1 illustrates an example of a finding a match of length L in accordance with a sliding window match scheme. As bytes in a byte stream 100 are received, a match detection scheme employing a sliding window is employed to determine whether there is an identical byte pattern that has been previously received and processed. The process stage shown in FIG. 1 corresponds to a state at which a prior portion of byte stream 100 has been received and processed, as illustrated by the History arrow and data in a history buffer 102 in which the sliding window portion of the byte stream is temporally stored. Accordingly, once the history buffer 102 is filled to the 32 KB limit, the content of history buffer 102 incrementally changes with each cycle, removing the oldest character and adding the last character in byte stream 100 that was processed. For illustrative purposes, byte stream 100 is depicted as a stream of alphanumeric characters, rather than individual bits, which would be how the data would be encoded in an actual byte stream. Also, for illustrative purposes, it is presumed that the alphanumeric characters are encoded as ASCII characters, such that each character is represented by 8 bits, or a single byte, thus the terminology “byte stream.” Other 8-bit encodings could also be employed.

The arrow depicting time T₀ corresponds to the start of a processing cycle in which a byte corresponding to a character ‘z’ is evaluated for a match. From a conceptual view, a pattern match operation is performed evaluating character ‘z’ against previously received characters (bitmap patterns) in byte stream 100. In the case of DEFLATE, the size of the history buffer is limited up to the previous 32K bytes of bitstream content. To evaluate the ‘z’ for a match, history buffer 102 will be searched for a match (which in this case would be a single individual character ‘z’ that may have been previously received). In this particular example, a prior character ‘z’ has not been received such that there is no match. According, a literal ‘z’will be forwarded for further processing, such as to an entropy coder.

Next, at a time T₁, a character ‘b’ is encountered. At time T₁ a search for character ‘b’ is commenced.” In this case a prior ‘b’ has been received (within the 32 KB sliding window), and thus there is a match. In response to a match, further searching will be performed by adding one additional character (in byte stream 100) at a time to create incrementally longer search strings with evaluation continuing until a string match is not found. During a processing cycle beginning at time T₂, a second character ‘c’ is added to ‘b’ to create a search string ‘b c’, which is searched for in history buffer 102. In one embodiment, a hashing scheme is implemented to facilitate string match searching, such as the hashing scheme defined for DEFLATE in RFC 1951. As before, a match is found, and the process is repeated again multiple times until we reach a cycle corresponding to time T_{L}. At this point, the search string ‘b c d e . . . 1 2’ is searched for a match. Since this same string has been previously retrieved, a match is found.

In conjunction with the foregoing string search evaluation sequence, for every added character to the string search window the corresponding character is added to a look-aside buffer 104 such that the string in the look-aside buffer at a given point in time matches the current search string window. Also, for each match result, data in a distance register 106 is updated to indicating the distance in bytes to the nearest match.

At a time T_{L+1} a character ‘J’ is encountered, such that the match string is now ‘b c d e . . . 1 2 J’. Meanwhile the next character in the prior match string is ‘y’ (and it is presumed that no other strings ‘b c d e . . . 1 2 J’ where previously received within the 32K sliding window. As a result, there is a miss. At this point, data indicating the length of the longest matched string in look-aside buffer 104 corresponding to the prior match (which can be obtained by removing the last added character) and data in the distance register 106 identifying the distance to the matched string is encoded as a token comprising a <len, distance> pair.

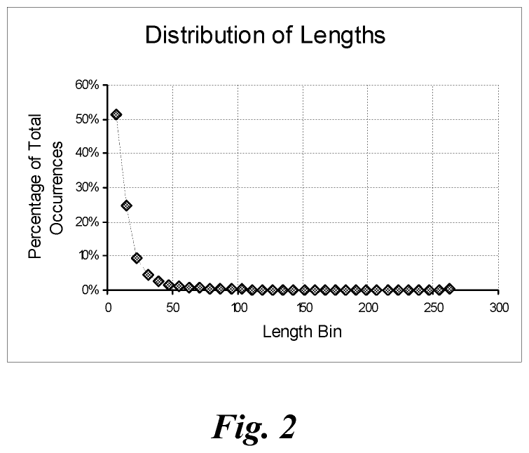

Under DEFLATE there can be a matching string length of up to 258 bytes. Under a conventional approach, a hardware look-aside buffer of at least 258 bytes would be used to ensure that any match of 258 bytes or less (that is, any legal DEFLATE string match) could be buffered. However, the frequency of encountering a string match of 258 bytes or more is extremely small. Moreover, the frequency of finding string matches based on length can be approximated as an inverse exponential equation under which the frequency falls off rapidly as the bit length increases. For example, the graph 200 in FIG. 2 is illustrative of the distribution of matching lengths as a percentage of occurrences one might find for a large corpus of files obtained, for example, from the top 500 web sites.

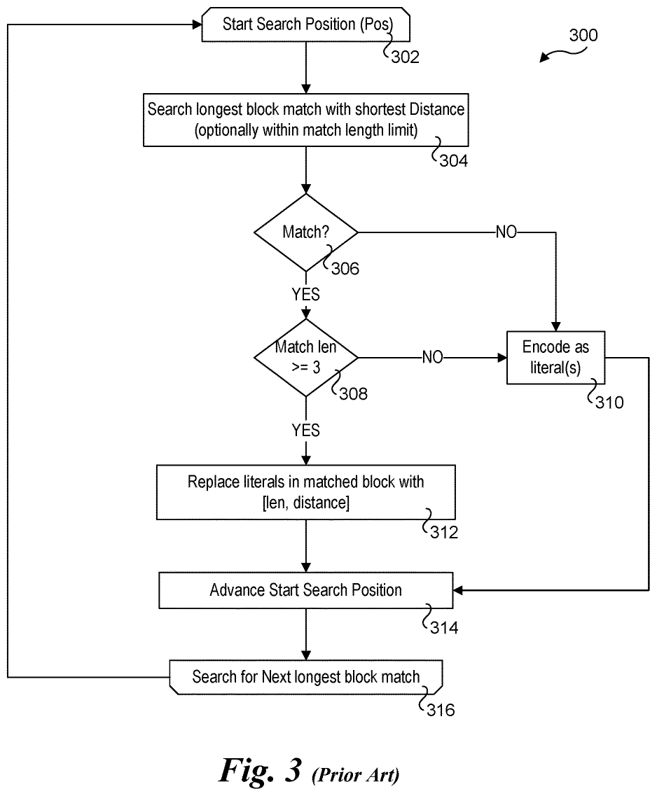

FIG. 3 shows a flowchart 300 illustrating operations and logic performed by a conventional implementation of the LZ77 compression scheme. As shown by start and end loop blocks 302 and 316, the operations are performed in a loop-wise manner until processing of the file (or whatever content is being encoded) is complete.

The loop begins with start loop block 302, which corresponds to the start of the search position (the position at which the next search process begins, referred to herein as ‘Pos’). In a block 304 a search for the longest block match with shortest distance is performed, optionally including a match length limit (e.g., the length of the longest match is limited). Details of this process are described above with reference to FIG. 1 and are well known. As depicted by decision block 306 and 308, if there is no match or if the longest match has a length that is less than 3, the logic proceeds to a block 310 in which the byte values are encoded as literals, and then to a block 314 where the start search position Pos is advanced by the number of literals that are encoded. The logic then proceeds to end loop block 316, which returns the processing to start loop block 302 to begin searching for the next longest match block in block 304.

If the result of the longest block match returns a block with a length of greater or equal to 3, the answer to decision block 308 will be YES, and the logic will proceed to replace the literals in the matched block with [len, distance], where len is the length of the match block and distance is the shortest distance to a previous block that is matched, as shown in block 312. As before, the start search position is advanced in block 314 (this time by len), and the logic loops back from end loop block 316 to start loop block to repeat the process.

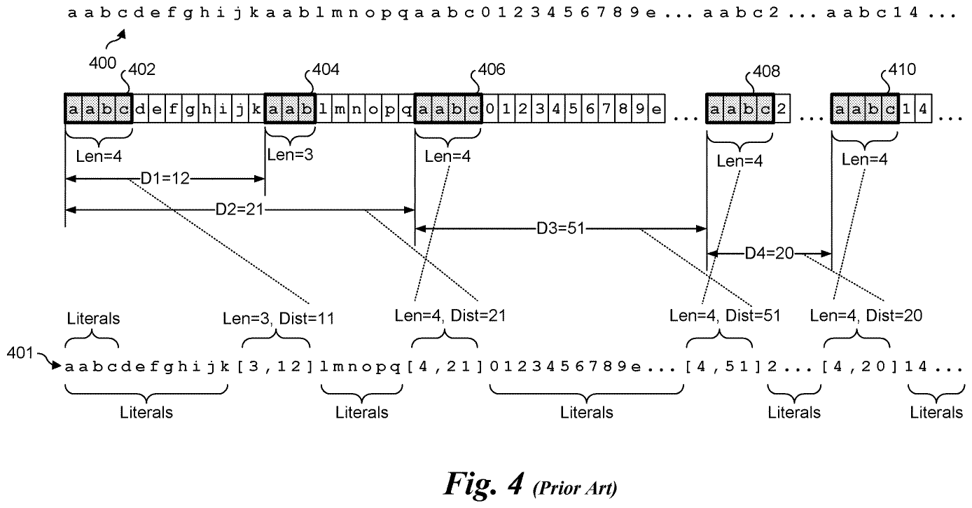

FIG. 4 depicts how a character string in a byte stream 400 is encoded into an encoded stream 401 using a conventional implementation of the LZ77 compression scheme using the operations and logic of flowchart 300. For illustrative purposes, the byte streams herein are shown using character strings rather than the actual byte values used by ASCII. As illustrated, the character string includes an ‘a a b c’ block 402, an ‘a a b’ block 404, an ‘a a b c’ block 406, an ‘a a b c’ block 408, and an ‘a a b c’ block 410 interspersed with various other alphanumeric characters. Since LZ77 encodes and decodes from a sliding window over previously seen characters, decompression must always start at the beginning of the input, which begins with ‘a’, ‘b’, ‘c’, ‘d’, ‘e’, etc. for byte stream 400. In this example implementation, the minimum matching length (‘len’) is 3, the same as used in DEFLATE.

Using the sliding window comparison scheme described above with reference to FIG. 1, no matches with a length of at least 3 would be detected until ‘a a b’ block 404 is reached, which matches the first three characters of ‘a a b c’ block 402. In accordance with decision block 306 and block 310 of flowchart 300, up until the position and the start of ‘a a b’ block 404, byte stream 400 would be encoded as literals ‘a’, ‘a’, ‘b’, ‘c’, ‘d’, ‘e’, ‘f,’ ‘g’, ‘h’, ‘i’, ‘j’, ‘k’ in encoded stream 401. Since the match of ‘a a b’ block 304 has a length of 3, the ASCII byte values for literals ‘a’, ‘a’, ‘b’ would be encoded as [3,12], representing a length of 3 at a distance of 12 from the matching ‘a a b’ substring in ‘a a b c’ block 302. Similarly, after a sequence of literals ‘l’, ‘m’, ‘n’, ‘o’, ‘p’, ‘q’, block ‘a a b c’ 306 would be encoded as [4, 21], followed by literals ‘0’, ‘1’, ‘2’, ‘3’, ‘4’, ‘5’, ‘6,’ ‘7’, ‘8’, ‘9’, ‘e’, . . . , [4, 51] for block ‘a a b c’308, literals ‘2’, . . . , [4, 20] for block ‘a a b c’310, and literals ‘1’, ‘4’. . . .

The process of decompressing DEFLATE streams is effectively the inverse of compressing DEFLATE streams and has two phases:
1. Decoding the input stream into tokens (literals or references to repeated strings)
2. Copying either the literal bytes or repeated strings (with specified length/offset) to the output stream (LZ77 back-end output generation)

In accordance with aspects of embodiments disclosed herein, a heterogeneous history (Hetero-History) for hardware accelerators, such as LZ77 hardware accelerators, is provided. The Hetero-History defines an architecture and implementation framework that allows compression and decompression cores to support different physical history sizes while maintaining deterministic behavior and a unified software programming model.

The embodiments provide several innovations and improvements, including use of explicit fields in architecture registers relating to supported minimum and maximum history sizes, descriptor fields with history size enumerations, and Analytics Engine Configuration and State (AECS) extensions to manage save/restore behavior of state between jobs. Other innovation include AUTO_PERF and AUTO_SIZE history-size directives in job descriptors, where AUTO_PERF ensures routing of decompression jobs to all Decompression (D)-cores, while AUTO_SIZE defines a maximizing compression ratio using history that could be larger than the smaller decompress cores.

Further innovations include ground rules for implementations that ensure cross-generation compatibility, deterministic decompression behavior, and simple software usage; a generalized history-mapping mechanism is provided where each core “pretends” to be the requested size—enabling correct behavior even when the physical history differs; relaxed dictionary-size constraints, enabling software to use larger dictionaries without depending on physical history size; and new AECS (data-structure containing execution state) semantics allowing safe and consistent loading/saving of history state across cores and generations.

The embodiments provide improvements and advantages over existing approaches. These include large hardware area savings by avoiding worst-case history memory replication across all cores; scalable to future formats (Zstd 256 KB+, 1 MB+) without redesigning the hardware/software interface; and deterministic decompression across different core types—no nondeterministic failures due to routing of decompression jobs to different class of decompress cores. Further advantages include a seamless software experience: one API (Application Program Interface), one descriptor/AECS model, and simple AUTO semantics.

Additional improvements include cross-generation compatibility: compressed data remains usable across mixed deployments; and improved performance flexibility: users can choose best performance (AUTO_PERF) or best size (AUTO_SIZE) without needing complex logic.

As used herein, compress cores and decompress cores are labeled with a numerical value referred to as a “size,” with sizes such as 16K, 32K, etc., that may be represented as simply ‘16,’ ‘32,’ etc. In this context, the size corresponds to the size of the history buffer the compress core or decompress core supports. Letter ‘C’ is used to represent compress cores, while letter(s) ‘D’ or ‘AD’ are used to represent decompress cores. For example, C16 refers to a compress core configured to implement a 16K history buffer, while D32 refers to a decompress core configured to implement up to a 32K history buffer. Decompress having a given size may be used to decompress compressed data that was compressed using a history size that is less than or equal to the given size. For example, a D32 decompress core may be used to decompress data that was compressed with any of a 4K, 8K, 16K, or 32K history buffer.

The accelerator will include new fields in an accelerator-capable register such as a DEVCAP or DEVCFG (device capabilities or device configuration) register(s) to indicate supported history sizes across compression and decompression. We also define three new History Size fields, located in:
Compress Descriptor
Decompress Descriptor
Decompress AECS
   They all accept enumerated values such as {0: 4K, 1: 8K, 2: 16K, 3: 32K, . . . }

The descriptor fields also accept AUTO directives (e.g., a flag at the end of the range), while the AECS field does not.

From a hardware perspective, the AUTO directives are identical to one of the other explicit values. It is a constant within a given generation, but it may change between generations.

The definitions of the AUTO directives are:
AUTO_SIZE=size of (largest) Compress core
AUTO_PERF=size of smaller Decompress core

From a user/software perspective, the behavior of the AUTO directives:
AUTO_SIZE: Absolute best compression ratio; may reduce decompress performance.
AUTO_PERF: Best compression ratio that allows for full performance decompress.

If users want to know what size they actually got with either AUTO directive, they could query the DEVCAP/DEVCFG registers and use the above definitions.

In one embodiment, the compress cores have single class and size of 16 KB (referred to a ‘C16’) while there are two decompress cores classes (sizes): 16 KB and 32 KB (respectively referred to as ‘D16’and ‘D32’). Each class can have an arbitrary number of cores.

Under respective exemplary and non-limiting embodiments the following combinations of classes and sizes are provided:
C16, D16, D32
C16, D32
C32, D16, D32
C32, D32

The foregoing concerns use in DEFLATE, which uses up to a 32K history buffer. If other algorithms are to be supported with history buffer size larger than 32K, the size(s) may be increased beyond 32K, and there are more possible combinations, as discussed and illustrated below. Some exemplary combinations supporting sizes beyond 32K include but are not limited to:
C16, D16, D64
C16, D16, D32, D64
C32, D16, D32, D64

Any of the foregoing where D64 is replaced with n*32, where n>2.

### Mapping Sizes to Cores/Basic Behavior

In some embodiments, there is only one size compression core, so the routing of compress descriptors doesn't depend on the specified size. The effective size is the smaller of the specified size and the physical size. The compression core will behave as if it were a core of the effective size. Reducing the history that the compression core could use, degrades ratio, but permits the data to be decompressed by smaller decompress cores. For decompression, the size may affect the routing.

The descriptor will be routed to a core that is at least as large as the specified size. The effective size will be the specified size, and the core will “pretend” it is a core of the specified size.

If all the cores are smaller than the specified size, then the descriptor will be routed to a core of the largest size. For instance, if there were decompress cores of size 8 and 16, and the specified size was 32, then the descriptor would only be routed to the 16. In this case, the effective size would be the physical size, but decompression would not generate an error unless there actually was a reference to a larger distance. For example, if the specified size was 32, the physical size was 16, but there were no references further back than 16K, then the decompress operation would not generate an error (at least not due to the size).

The rationale for having decompress cores pretend they are smaller is as follows. Consider the case where there are 16K and 32K decompress cores, and the user specifies a size of 16. One might think that since a 16K stream can be decoded successfully with a 32K core, why should the core pretend to be 16K?

The descriptor could be routed to any core depending on dynamic load conditions. Assume that the stream contained a reference with a distance of 20K. If it was sent to a 16K core, decompression would result in an error. If it was routed to a 32K core, and that core operated as a 32K core, then it would not generate an error. This would result in the same job getting one of two different results depending on which core it was assigned to. In other words, the results would be “non-deterministic” because there could be different results with the same input. To avoid this, the 32K core would have to pretend to be a 16K core in this case.

In the case where there were 8K and 16K cores, and the user specified 32K, then there is no issue with determinism. The 16K core would behave as a 16K core, but the descriptor would not be routed to the 8K core, so there is no issue with distances between 8 and 16.

### Mapping Use Cases to Sizes

The following is a list of cases to take care of, according to one embodiment:
1. Compress or decompress compatible with all generations Compress 4K
2. Compress to be decompressed on this or future generations Compress AUTO*
3. Decompress file from unrestricted 3rd party app (e.g., zlib) Decomp 32K (DEFLATE)
4. Compress or decompress on a sea of machines Compress with min (decomp sizes across machines)

The complex (last) case is where the user wants to compress and decompress on a sea of machines, which contain different generations.

In this example, assume that an existing generation is (C16, D16, D32) and a future generation is (C32, D32). In this case, all the compression and decompression should be done with a size of 16K. The compress size would need to be 16K so that the output could be decompressed by everyone, and the decompress size would have to be 16K so that the descriptor could be routed to everyone.

The question in this case is how does the user determine that the appropriate size in this case is 16K? They should look at the DEVCAP/DEVCFG fields for all the processors they have, and see what decompress minimum sizes they find. Note it's possible that there is an older accelerators in the fleet which does not have the new fields defined for heterogeneous history; in that case we know history is 4 KB for compress and decompress.

In theory, this could produce a size larger than the compress size. For example, if one generation contained (C16, D32) and the other contained (C32, D32), then the user would want to specify a size of 32, as this could be decompressed by everyone. On some of the machines, this would be “downgraded” to 16K during compression, but that wouldn't be a problem; we can't do better on that generation anyway.

Another related case is where the user has a sea of machines starting with Generation X and continuing with later generations, and they want to compress with a limited 3rd party tool (e.g., zlib) which allows limiting the compression behavior, and decompress with any of these the generations. In this case, they would want to look at the minimum decompress size for their Generation-X machines and use this history size when running the 3rd party compression tool.

### Decompress AECS History Size

There is also a new History Size field in the AECS that represents what size the history buffer was when the AECS was written/created. This is needed, for example, when the write pointer is 0 and the wrap bit is set. Then the amount of data in the history buffer is equal to the history buffer size (which is now stored in the AECS).

### Compress AECS History Size

There is no need to add a new history size field in the compress AECS, because there is no history in the compress AECS.

There is something similar, however, in the context of dictionary processing. In LZ77 algorithm implementations, a dictionary can be treated as history data; for decompression it's really serving exactly that purpose for references that hit the dictionary, while for compression we also have to index the dictionary into the hash table while loading it into history buffer to enable finding matches in that dictionary.

When loading a new style dictionary, the dictionary size is implied by the src2 size; this size can be any power-of-two size between 1K and 32K (for DEFLATE), regardless of the size specified in the descriptor. For example, a user might be compressing on a number of different machines, some of which have 16K compress cores and some of which have 32K cores. Presumably, they would specify the compress history size as AUTO*. It would be reasonable for them to want to use a 32K dictionary, to be able to take advantage of the larger history on the C32 machines, but we would want the code to still work (with less ratio) when run on the C16 machines.

### Decompress Write Pointer and Wrap Bit

In one embodiment, there are four fields in the AECS associated with the history buffer:
1. The history buffer data itself
2. The size of the history buffer
3. The write pointer
4. The wrap bit.

One way to think of the wrap bit is if the wrap bit is clear, then the first portion of the history buffer contains data, and the second portion is empty, and if the wrap bit is set, then all of the history buffer contains data. For example, if the history size was 4K, the write pointer was 1K, and the wrap bit was set, then the first quarter of the history buffer would contain data from 32K to 33K, and the second three quarters would contain data from 29K to 32K. If the wrap bit was clear, then the first quarter would contain data from 0 to 1K, and the second three quarters would be empty.

In one embodiment there is an existing check in current accelerator generations that requires that the wrap bit be set if the write pointer is greater than or equal to the history size.

### Rules for Loading Decompress AECS with Different History Sizes

We need to define a new set of rules for loading a decompress AECS depending on various combinations of the AECS size, the core effective size, and the write pointer.

In particular, we're assuming that if we have a multi-chunk decompression, then the history buffer size will not change halfway through. For example, we wouldn't compress the first half with 16K and the second half with 32K, or vice versa. This would tend to suggest that the AECS history size should always match the core effective size, but there is a major exception.

The primary case for having the AECS size and the core effective size being different is when we do dictionary decompression with the new-style dictionary. Consider the case where the user had a sea of different generations, where some were (C16, D16, D32) and some were (C32, D32). Assume that each core is going to be decompressing data that it compressed; i.e. there is no data sharing between processors. They want to run the same code on all of the machines. They would use AUTO_PERF, so that on one machine, they would get 16K histories and on the other 32K.

To keep software complexity minimal, they would want to create an AECS with a 32K history buffer, in case it was being used on a 32k machine, but that same image should also work on a 16K machine.

In one embodiment the allowed cases in with AECS loading with hetero histories are:
1. Wrap bit is 0.
2. The write pointer mod AECS history size is 0. (i.e., the write pointer is a multiple of the AECS history size).
3. The AECS history size matches the descriptor history size.

The typical case of an arbitrary AECS state in the middle of a multi-chunk decompression would be case 3 (we're not trying to change the size).

The other two cases correspond to an AECS created for dictionary decompression.

Case 1 is the simple case where the data is in the first portion of the history buffer (e.g., starting at 0) and is less than the history size for which the AECS was created. For example, the history buffer size might be 16K, but we only have a 2K dictionary.

Case 2 is the case described earlier in this section. The dictionary size is 32K, but the descriptor history buffer size was AUTO*, which for this machine translates to 16K (e.g.,). This case is easy for hardware to handle. It just loads the history data into the history buffer, wrapping when it gets to the history buffer size. In this example, it would write the first 16K data into the history buffer, and then overwrite it with the second 16K of data.

The new AECS loading rules are important because they enable dictionary decompression across heterogeneous cores, while also keeping only the right behaviors for state save/restore for multi-chunk jobs.

The compress and decompress cores pretend to be a core of specified size. This is needed for deterministic behavior. Specifically, the compress hardware needs to artificially clip backward-reference comparator results to ensure it won't encode references from the possibly larger physical history. In the case of decompression, the hardware needs to manage state loading carefully and use a restricted effective-address mask while doing the full decompress operation including saving state.

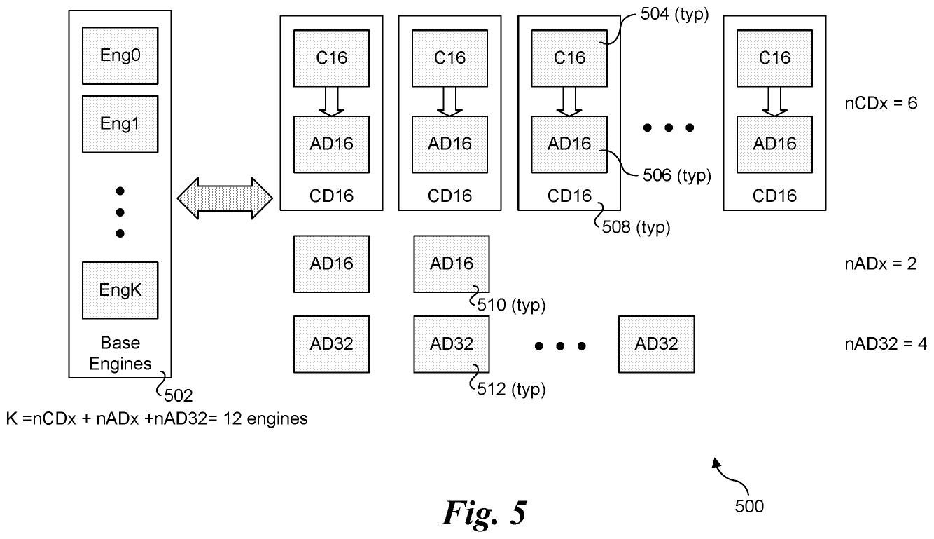

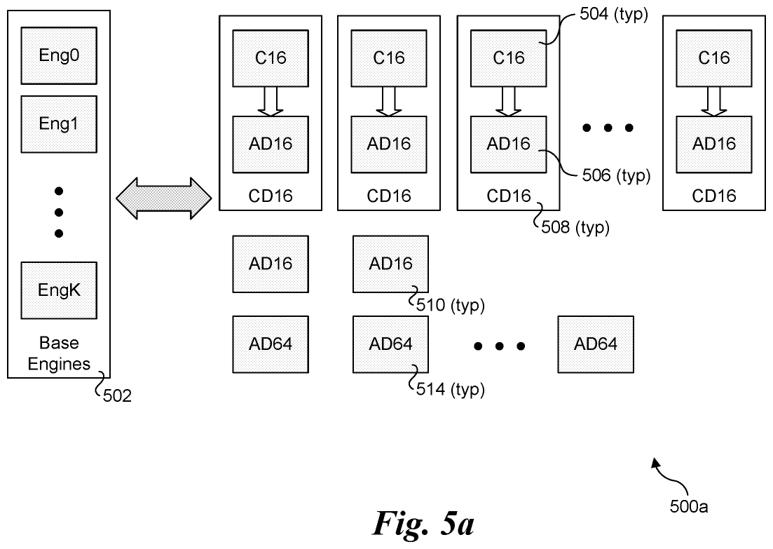

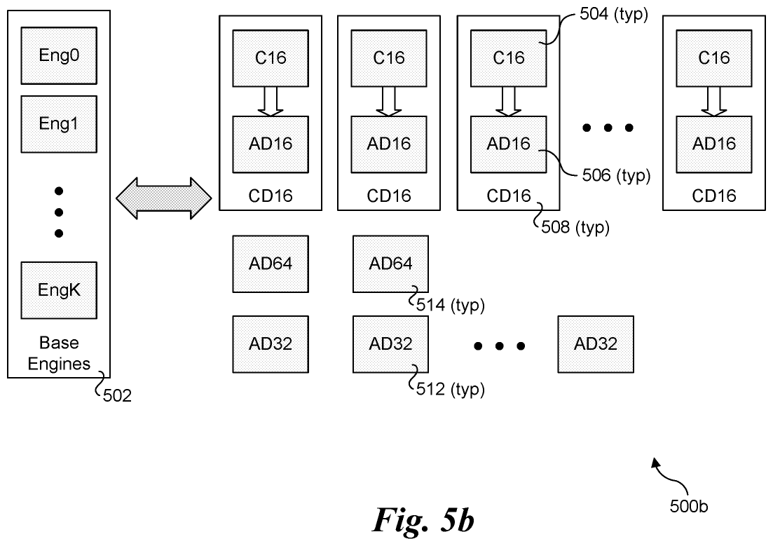

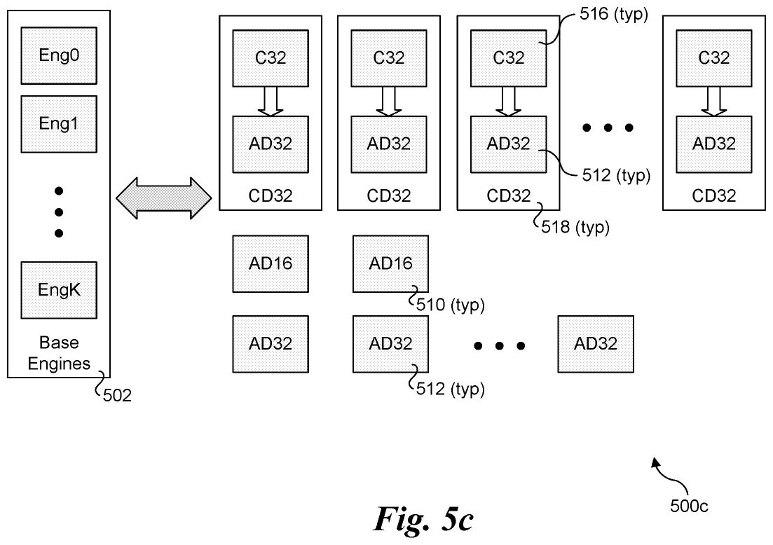

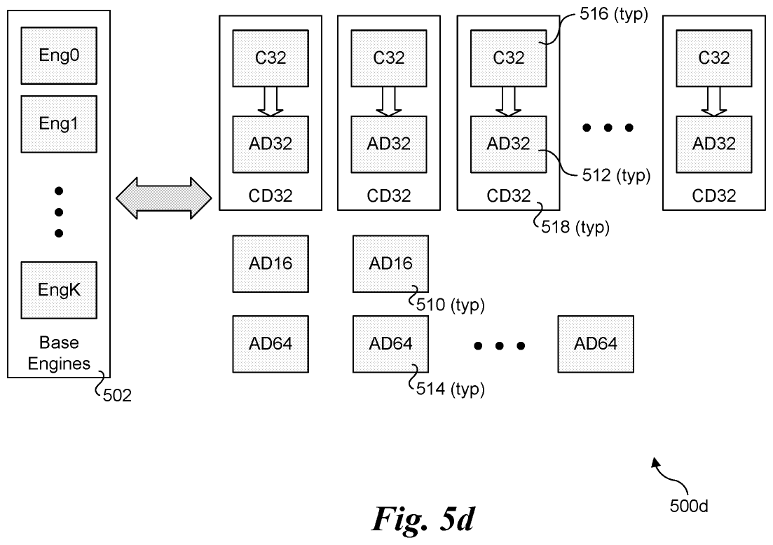

FIGS. 5, 5a, 5b, 5c, 5d, show diagrams illustrating examples of compress/decompress accelerators including base engines, compress cores, and decompress cores, according to respective embodiments. In each of the compress/decompress accelerators, base engines 502 manage the data streams for each job. While “data stream” is referred to here, for a given job the data stream may also be a data file that is to be compressed or decompressed by processing the data file as a data stream.

In compress/decompress accelerator 500 of FIG. 5, there are six C16 compress cores 504 that are bound to six AD16 decompress cores 506 in six CD16 blocks 508. By binding a compress core with a decompress core, a fused compress-verify function is supported. Optionally, a decompress core in a CD block may be used for decompression operations when other decompress cores are not available and when its associated compress core is idle. There are two additional D16 decompress cores 510 (labeled “AD16”) which are free and not bound to compress jobs. There are four large D32 decompress cores 512 (labeled “AD32”). The “A” in “AD” stands for analytics operations that are outside the scope of this disclosure.

In one embodiment, compression may be selectively performed without compress-verify. For example, this option may be indicated via data in a compress descriptor. Under this embodiment, the base engines would include routing/arbitration circuitry and logic to enable a corresponding compression job to be assigned to one of the C16 cores 504.

FIG. 5a shows compress/decompress accelerator 500a that is a variant of compress/decompress accelerator 500 where AD32 decompress cores 512 have been replaced by AD64 decompress cores 514. In a similar manner, the larger size decompress cores may have sizes such as 128, 256, 512, 1024, etc.

Under compress/decompress accelerator 500b of FIG. 5b, the “free” accelerators include two AD64 decompress cores 514 and four AD32 decompress cores 512. The C16 compress cores 504 and AD16 decompress cores 506 in the six CD16 blocks 508 are the same as shown in FIG. 5.

Compress/decompress accelerator 500c of FIG. 5c includes six CD32 blocks 518 including six C32 compress cores 516 that are bound to six AD32 decompress cores 512. The free depress cores include two AD16 decompress cores 510 and four AD32 decompress cores 512. Compress/decompress accelerator 500d of FIG. 5d is similar to compress/decompress accelerator 500c, except the AD32 decompress cores 512 have been replaced with AD64 decompress cores 514.

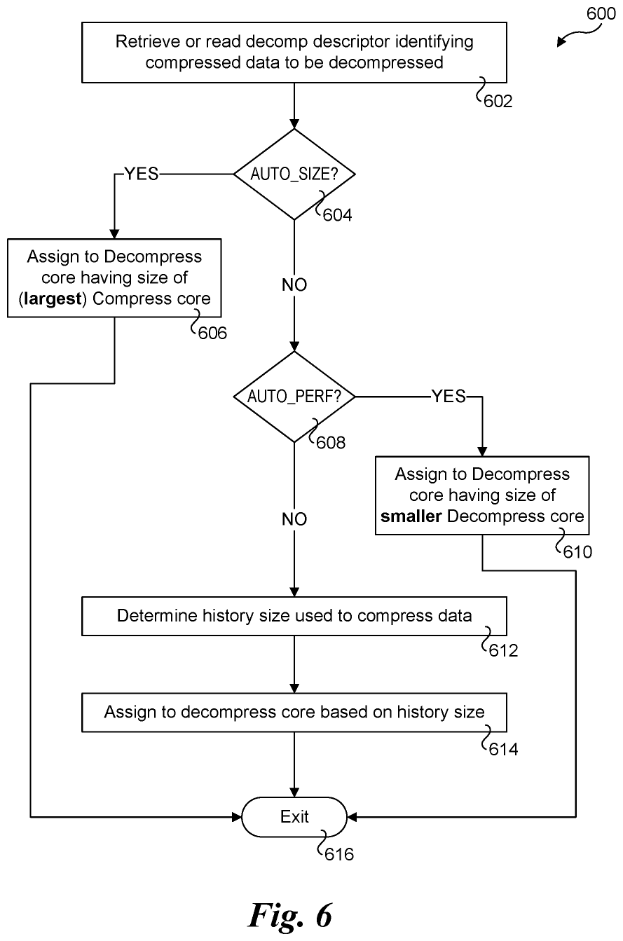

The two AUTO directives, which may be implemented as AUTO flags greatly simplify software enablement, while also providing explicit hooks for history sizes supported in the device and for descriptor submissions for advanced usages. FIG. 6 is a flowchart 600 illustrating operations and logic associated with use of AUTO_SIZE and AUTO_PERF flags. In one embodiment, the operations and logic are implemented by a base engine. The process begins in a block 602 in which a decompression (decomp) descriptor identifying compress data to be read is retrieved or read by the base engine. In a decision block 604, a determination is made to whether the decomp descriptor includes and AUTO_SIZE flag. If the answer is YES, the logic proceeds to a block 606 in which the base engine assigns the work to a decompress core having the size of the (largest) compress core. The logic then proceeds to exit at end block 616.

If there is no AUTO_SIZE flag, the answer to decision block 604 is NO and the logic proceeds to a decision block 608 to determine whether there is an AUTO_PERF flag. If there is, the answer to decision block 608 is YES and the logic proceeds to a block 610 to assign the work to a decompress core having a size of the smaller decompress core, and then exits at end block 616. If the there is no AUTO_PERF flag in the decomp descriptor, the answer to decision block 608 is NO and the logic proceeds to a block 612 in which the history size used to compress the data is determined, with the work assigned to a decompress core in a block 614 based on the history size determined in block 612. The process then exits at end block 616.

### Exemplary Platform Configurations

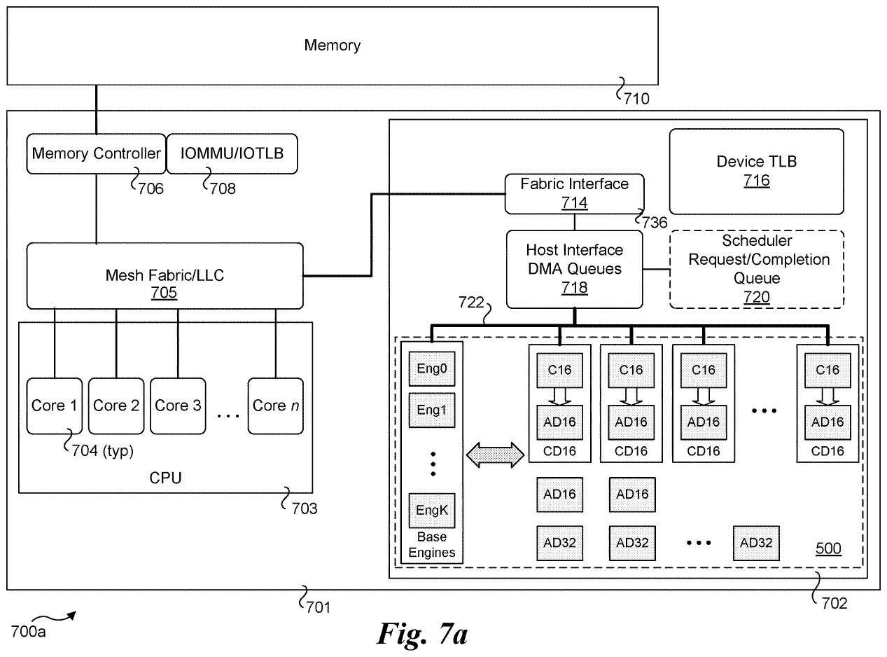

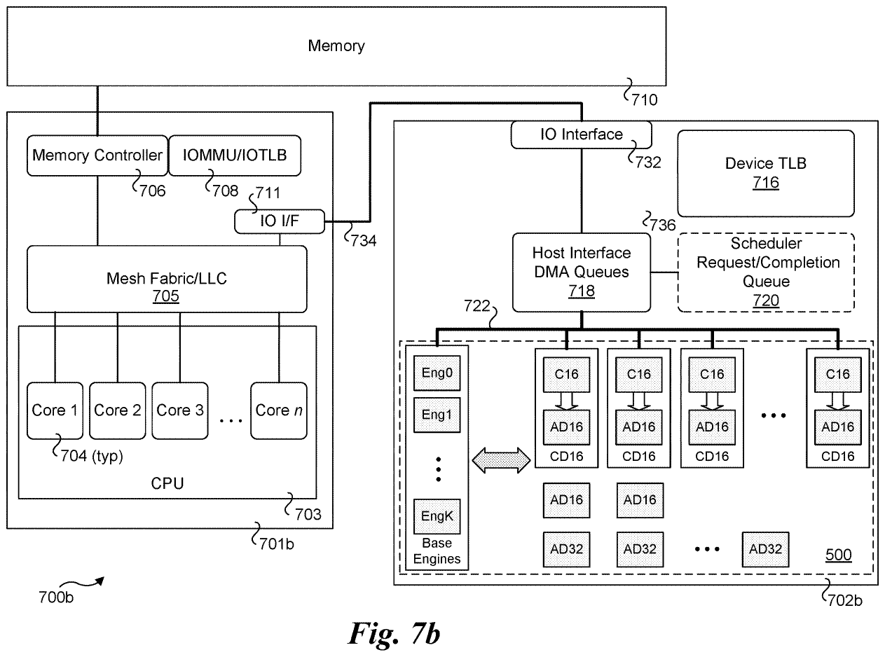

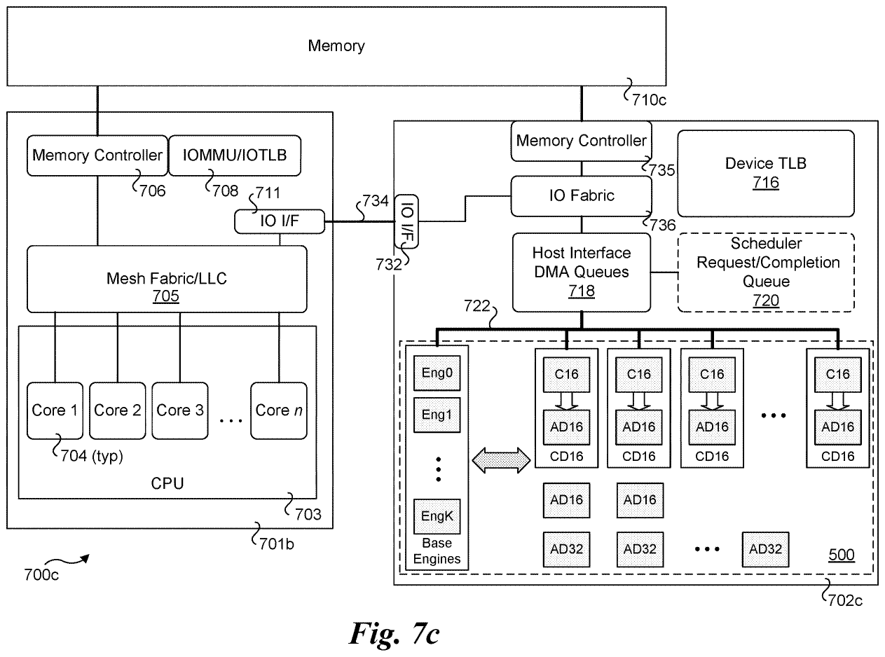

FIG. 7a shows a platform architecture 700a including a processor 701 having an on-chip accelerator complex 702 supporting multiple instances of accelerator functions such as compression and decompression. Processor 701 includes a Central Processing Unit (CPU) 703 including n cores 704, each with a private L1 and L2 cache (not shown). Each of cores 704 is connected to a mesh fabric/LLC (last-level cache) block 705, which is coupled to a memory controller 706 with an associated Input-Output Memory Management Unit and Input-Output Translation Lookaside Buffer (IOMMU/IOTLB) 708. Memory controller 706 is coupled to memory 710, which is illustrative of one or more DRAM memory devices, such as DDR5 or DDR6 DIMMS. Memory 710 may also be implemented using one or more Non-Volatile DIMMs (NVDIMMs). Generally, Memory controller 706 would be coupled to the DRAM memory devices with one or more memory channels per DRAM memory device (not shown).

FIG. 7a further shows an embodiment of an on-chip accelerator complex 702, which is representative of various types of accelerator complexes including compress/decompress accelerators. On-chip accelerator complex 702 includes a fabric interface 714, a device TLB 716, host interface DMA queues 718, an optional scheduler request/completion queue 720, and a bus 722 coupled to base engines, compress cores and decompress cores in compress/decompress accelerator 500. Fabric interface 714 is generally illustrative of various types of IO interfaces that can connect an on-chip accelerator to the interconnect infrastructure on the processor/SoC, as collectively illustrated and described herein as a mesh fabric. The interconnect structure and protocol may generally include both proprietary and standards-based interconnects. In some embodiments, jobs are queued in host interface DMA queues and accessed from the DMA queues rather than from memory 710. Optional scheduler request/completion queue 720 may be used to schedule processing of jobs and/or implement a completion queue to mark when jobs are finished.

Variants of processors with on-chip accelerators including processors having the CPU and accelerator complex on a single die, on separate dies, or on separate tiles or so called “chiplets.” While compress/decompress accelerator 500 is shown here, other embodiments may include any of compress/decompress accelerator 500a, 500b, 500c, or 500d or variants thereof.

FIG. 7b shows a platform architecture 700b comprising a variant of architecture 700a in which the processor 701b and accelerator complex 702b are separate components, and wherein like-numbered components in architectures 700a and 700b perform similar operations and/or functions. Under architecture 700b, processor 701b includes an IO (Input-Output) interface (I/F) 711 that is coupled to an IO interface 732 on accelerator complex 702b via a link 734. In one embodiment, IO interfaces 711 and 732 are Peripheral Component Interconnect Express (PCIe) interfaces, and link 734 is a PCIe link comprising any of 1, 2, 4, 8, 16, or 32 lanes. In this embodiment, IO interface 711 is a PCIe Root Port that is coupled to a PCIe Root Complex (not shown), and accelerator complex 702b is able to read from and write to memory 710 using PCIe DMA transactions.

FIG. 7c shows a platform architecture 700c comprising a variant of architecture 700b in which an accelerator complex 702c further includes a memory controller 735 that is coupled to a dual-port memory 710c. IO interface 732 and memory controller 735 are coupled to an IO fabric 736. Under platform architecture 700c, accelerator complex 702c is able to directly write to and read from dual port memory 710c.

### Exemplary Systems and Implementation Environments

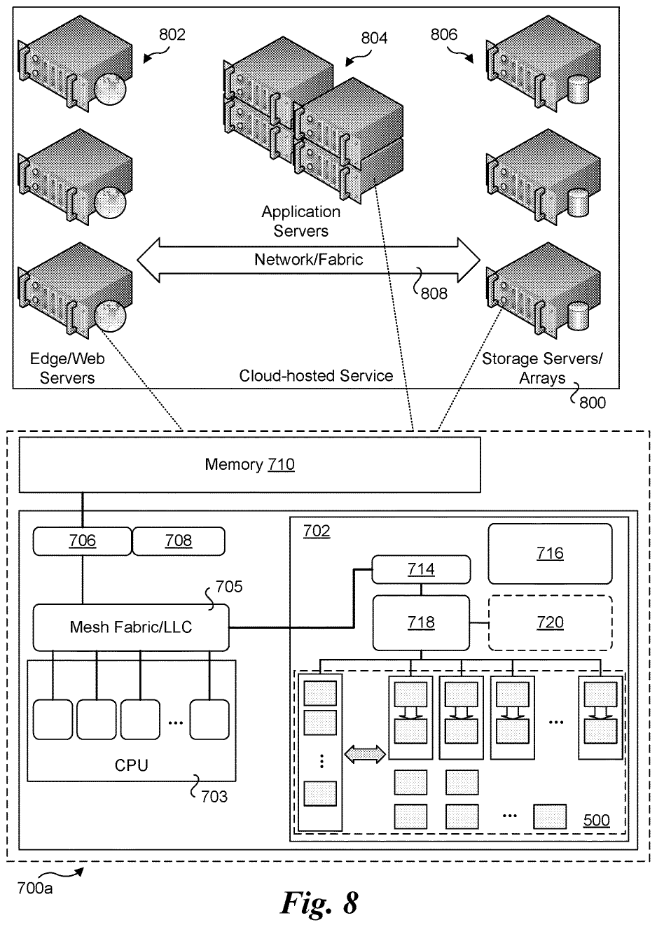

Exemplary systems and environments for which aspects of the embodiments described and illustrated herein may be implemented are shown in FIGS. 8, 9a, 9b, 9c, and 10. FIG. 8 shows a system including a cloud-hosted service 800 that provides various services including data storage services to various clients (not shown) via the Internet. In this illustrated example, cloud-hosted service 800 employs a 3-tier architecture comprising a “front-end” Web server tier including a plurality of Web servers 802, and application server tier including a plurality of application servers 804, and a “back-end” or storage tier including a plurality of storage servers and/or storage arrays 806. Alternative, edge servers may be used in place of Web servers or there could be an edge server tier that interfaces with other server tiers in cloud-hosted service 800. The various servers and storage components employed by cloud-hosted service 802 are coupled in communication via one or more networks and/or fabrics, collectively depicted as network/fabric 808 for simplicity. Generally, in some implementations or uses, Web servers 802 may communicate directly with storage servers/arrays 806, while in other implementations the communication paths between the Web server tier and the storage tier includes application servers 804.

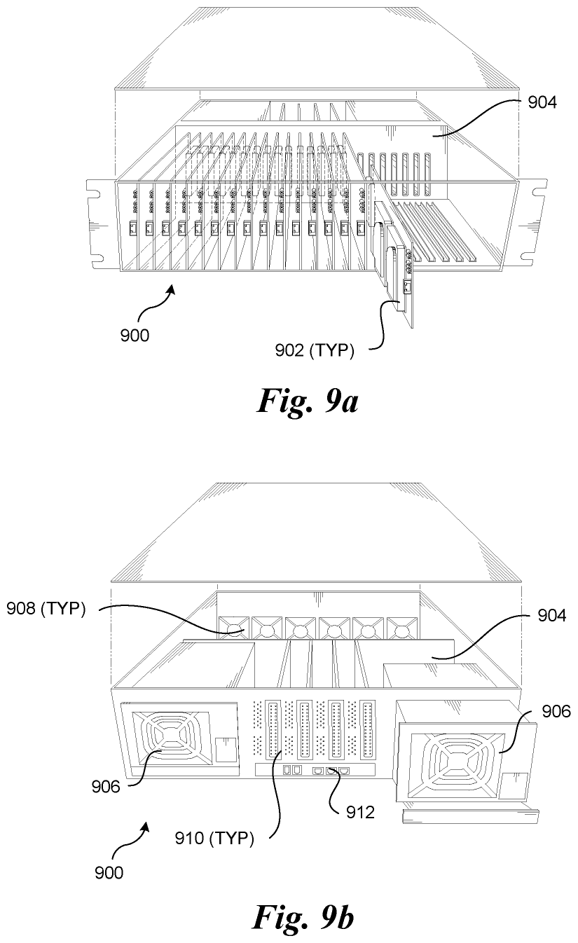

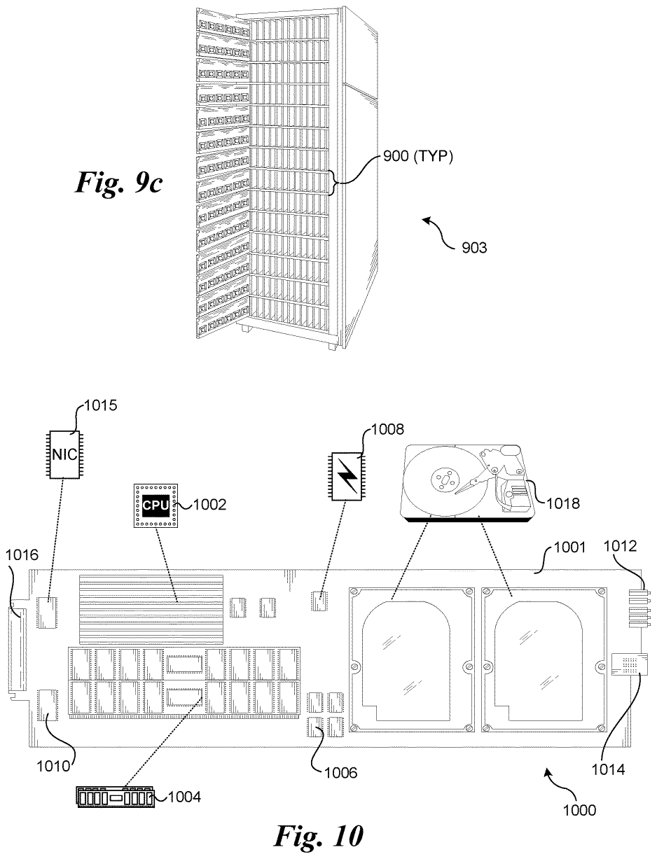

Under some embodiments, the servers and other components depicted in FIG. 8 are installed in a data center or the like. In addition to the components shown, the data center may have other components such as load balancers, and various networking equipment, such as top-of-rack (TOR) switches, as well as management components typically employed in data centers. Details of a blade server architecture that may be used for servers in one or more of the tiers are discussed below with reference to FIGS. 9a-c and 10. Under other embodiments, a cloud-hosted service may lease equipment from companies such as Amazon (Amazon Web Services or AWS), Microsoft (Microsoft Cloud or Microsoft Azure), Google (Google Cloud), and others. Similar cloud services may be implemented using disaggregated architectures employing separate pools of compute, memory, accelerators, storage, etc. So called “serverless” cloud services using distributed microservices may also be implemented

Web servers 802 are configured to provide communication with clients via the Internet. This will usually be facilitated using a conventional networking stack such as HTTP or HTTPS over TCP/IP, under which file transfers may employ a streaming connection or may employ a chunk-based transfer mechanism. In some embodiments, Web servers 802 will be configured to implement a Web service using a RESTful interface with JSON and/or XML, while other types of Web service interfaces, such as SOAP, may also be used.

As their name implies, application servers 804 are used to host applications. Under a cloud-hosted storage service, an application may be employed for accessing data that is stored in storage devices in the storage tier. In addition, application servers 804 may be employed to perform storage replication under which copies of data are stored in data centers at separate geographic locations. Application servers may also include database servers or may support various other types of data architecture schemes. Depending on the required scale, some cloud-hosted services may implement application server functions in the Web servers and/or the storage servers (employing a 2-tier architecture), while other services may employ a 3-tier architecture. 4-tier architectures (not shown) may also be implemented, as well as other architectures used for cloud-based services and the like.

The networks and fabrics within a data center are private. They can implement various protocols, including standardized protocols such as TCP/IP, as well as proprietary protocols. Moreover, streaming between tiers within a data center may be implemented with or without HTTP/HTTPS. In addition, since the servers and application software is managed by the cloud-hosted service provider, the software can be configured to support parity-encoded compression decompression for transfers within the data center using pre-determined schemes that do not involve including what parity scheme to use in the headers of the files. At the same time, including the parity information in file headers may also be used.

Communication between Web servers 802 and clients may use conventional compression/decompression such as conventional DEFLATE or other compression/decompression schemes, with compression/decompression schemes in hardware compression/decompression accelerators disclose herein. For example, storage services such as DropBox, Microsoft OneDrive, Google Drive, Box, etc., all include client applications that run on clients to facilitate communication between client devices running the client applications and storage services hosted in one or more data centers.

In view of the foregoing, various implementations of the compression match sharing scheme in hardware compression accelerators may be used, including but not limited to some of the following examples. In important aspect of the embodiments disclosed herein is the compressed files that are generated are formatted in accordance with a compression/decompression standard, such as but no limited to DEFLATE. As a result, conventional decompression software may be used. Accordingly, under an embodiment employing conventional compression/decompression for a client, a file may be stored in a format such as gzip or PKZIP on a storage device in the cloud-hosted server under which the file was created using a compression match sharing scheme in hardware compression accelerators. For transfer of that file within the cloud-hosted service, such as between the storage tier and the application server tier, between the application server tier and the Web server tier, or between the storage tier and the Web server tier, a decompressor configured to implement gzip or PKZIP file may be employed. Meanwhile, file contents that are compressed using a compress core may be streamed from a Web server 802 or an edge server to various clients and decompressed/decoded without any modification to the conventional gzip or PKZIP (or any other file format implementing conventional DEFLATE) decompressor on the client.

Generally, it is envisioned that aspects of the embodiments herein may be implemented in various types of computing equipment and devices, such as blade servers and other types of servers employed in a data center and/or server farm environment. Typically, the servers used in data centers and server farms comprise arrayed server configurations such as rack-based servers or blade servers. These servers are interconnected in communication via various network provisions, such as partitioning sets of servers into LANs with appropriate switching and routing facilities between the LANs to form a private Intranet. For example, cloud-hosting facilities may typically employ large data centers with a multitude of racks filed with various configurations of servers.

As an overview, exemplary blade server components and systems are shown in FIGS. 9a-c, and 10. Under one configuration, a rack-mounted chassis 900 is employed to provide power and communication functions for a plurality of server blades (e.g., blades) 902, each of which occupies a corresponding slot in the chassis. (It is noted that all slots in a chassis do not need to be occupied.) In turn, one or more chassis 900 may be installed in a blade server rack 903 shown in FIG. 9c. Each blade is coupled to an interface plane 904 (e.g., a backplane or mid-plane) upon installation via one or more mating connectors. Generally, the interface plane may include a plurality of respective mating connectors that provide power and communication signals to the blades, and including routed signal paths for coupling network signals or fabric signals between blades. Under current practices, many interface planes provide “hot-swapping” functionality—that is, blades can be added or removed (“hot-swapped”) on the fly, without taking the entire chassis down through appropriate power and data signal buffering.

An exemplary mid-plane interface plane configuration is shown in FIGS. 9a and 9b. The backside of interface plane 904 is coupled to one or more power supplies 906. Oftentimes, the power supplies are redundant and hot-swappable, being coupled to appropriate power planes and conditioning circuitry to enable continued operation in the event of a power supply failure. In an optional configuration, an array of power supplies may be used to supply power to an entire rack of blades, wherein there is not a one-to-one power supply-to-chassis correspondence. A plurality of cooling fans 908 are employed to draw air through the chassis to cool the server blades.

Blade servers generally include the ability to communicate externally with other IT infrastructure, either via communication functionality on the blade server itself or through communication via the midplane or backplane with another card installed in the chassis. For example, this may be facilitated via one or more network connect cards 910, each of which is coupled to interface plane 904. Generally, a network connect card may include a physical interface comprising a plurality of network port connections (e.g., RJ-45 ports for wired Ethernet, a SFP or SFP+port for an optical link, a silicon photonics port, etc.), or may comprise a high-density connector designed to directly connect to a network device, such as a network switch, hub, or router. Under disaggregated architectures other types of communication may be provided, such as communication over proprietary fabrics and PCI Express. Systems implementing Open Compute components and architectures may also be used.

Blade servers may provide some type of management interface for managing operations of the individual blades. This may generally be facilitated by a built-in network or communication channel or channels. For example, one or more buses for facilitating a “private” or “management” network and appropriate switching may be built into the interface plane, or a private network may be implemented through closely-coupled network cabling and a network. Optionally, the switching and other management functionality may be provided by a management switch card 912 that is coupled to the backside or frontside of the interface plane. As yet another option, a management or configuration server may be employed to manage blade activities, wherein communications are handled via standard computer networking infrastructure, for example, Ethernet or an optical network.

With reference to FIG. 10, further details of an exemplary blade 1000 are shown. Each blade comprises a separate computing platform that is configured to perform server-type functions, e.g., is a “server on a card.” Accordingly, each blade includes components common to conventional servers, including a main printed circuit board (main board) 1001 providing internal wiring (e.g., buses) for coupling appropriate integrated circuits (ICs) and other components mounted to the board. These components include one or more processors 1002 coupled to system memory 1004 (e.g., some form of Random Access Memory (RAM)), one or more accelerators 1006 (optional), and a firmware storage device 1008 (e.g., flash memory). A NIC (network interface controller) chip 1010 is provided for supporting conventional network communication functions, such as to support communication between a blade and external network infrastructure. Other illustrated components include status LED (light-emitting diodes) 1012, a set of RJ-45 console ports 1014 (only one of which is shown for simplicity), and a NIC 1015 coupled to an interface plane connector 1016. Additional components include various passive components (e.g., resistors, capacitors), power conditioning components, and peripheral device connectors. Other types of NICs and ports may also be used, such as SPF or SPF+ports.

Some blades may also provide on-board storage. This is generally facilitated via one or more built-in disk controllers and corresponding connectors to which one or more disk drives 1018 are coupled. For example, common disk controllers include SATA controllers, SCSI controllers, and the like. Other types of disk controllers may also be used. Additionally, solid state drive (SSD) may be used in place of disk drive 1018. As an option, the disk drives may be housed separate from the blades in the same or a separate rack, such as might be the case when a network-attached storage (NAS) appliance or backend storage sub-system that is employed for storing large volumes of data. Under a disaggregated architecture storage devices may be installed in pooled storage drawers that are separate from pooled compute drawers in which server blades or server modules are installed.

In addition to the illustrated components, a blade or other type of compute platform may include one or more accelerators that may be used to implement the compression match sharing scheme in hardware compression accelerators. For example, accelerators may be included in a processor SoC (System on a Chip) or SoP (System on Package) and/or may be implemented in a separate discrete component.

Generally, a client device may include any type of computing device or system that is configured to communicate over a network and run suitable compression/decompression software. Such computing devices include but are not limited to laptops, notebooks, desktop computers, workstations, mobile phones, tablets, etc.

Network interface(s) may include one or more of wired and wireless interfaces that support communication over one or more networks. For example, desktops, laptops, notebooks, and all-in-one computers may include Ethernet interfaces or adaptors, as well as an IEEE 802.11-based wireless (Wi-Fi) interface. Tablets and mobile phones may include mobile radios to support communication over mobile networks, as well as Wi-Fi interfaces.

Generally, an accelerator may include embedded circuitry and logic that is tailored to efficiently perform one or more specialized tasks, such as the compression and decompression functions described and illustrated herein. The circuitry may be in the form of a core executing program instructions, an ASIC (application-specific integrated circuit), or may include programmable circuitry/logic, such as provided via an FPGA. Such an FPGA may comprise one or more FPGA blocks, such as are available via license from various manufacturers. An FPGA block may also incorporate a custom design. Generally, the ASIC, FPGA block, or similar embedded circuitry and logic is referred to herein as a functional unit, which is designed to perform a corresponding function. A given accelerator may include one or more functional units.

More generally, an accelerator may also be referred to as an “core,” wherein the core may be programmed to perform one or more dedicated functions. In some embodiments, a core may operate in a similar manner to an embedded processor, and be enabled to execute instructions (e.g., accelerator application/function instructions) for dedicated functions. An core may also combine both execution of instructions in combination with embedded circuitry and logic.

Generally, the teachings and principles disclosed in the embodiments herein may be implemented for any application employing compression of data, such as but not limited to data files and byte streams. The hardware-based compression solutions disclosed herein provide improvement over existing schemes including compressing data at faster rates and greater compression levels.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

In addition to embedding the circuitry, logic, and components in the embodiments herein in CPUs, SoCs, and SoPs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processing Units (DPUs), Infrastructure Processing Units (IPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

The following examples pertain to additional examples of the teachings and principles disclosed herein.

Example 1. An apparatus, comprising a plurality of compress cores and a plurality of decompress cores. The decompress cores include first decompress cores, configured to perform decompression operations using a history buffer having a first size, and second decompress cores, configured to perform decompression operations using a history buffer having a second size larger than the first size. The apparatus also includes routing and arbitration circuitry to assign compression operations to compression cores, and assign decompression operations to the first decompress cores and the second decompress cores.

Example 2. The apparatus of example 1, wherein the circuitry is further configured to determine a history size used for compressing a compressed data stream to be decompressed, and when it is determined the history size is less than or equal to the first history size, assign decompression of the compressed data stream to a first decompress core if one is available; otherwise, assign decompression of the compressed data stream to a second decompress core.

Example 3. The apparatus of example 1 or 2, wherein, for each of at least a portion of the plurality of compress cores the compress core is combined with a decompression core in a respective compress-decompress (CD) block.

Example 4. The apparatus of example 3, where the compress and decompress cores in a CD block are configured to respectively perform compression and decompression operations using the first history size.

Example 5. The apparatus of any of the preceding examples, wherein the compress cores are configured to perform compression operations using the first history size.

Example 6. The apparatus of any of the preceding examples, further comprising a plurality of base engines configured to manage data streams for which at least one of compression and decompression is to be performed, wherein the routing and arbitration circuitry and logic is implemented in the plurality of base engines.

Example 7. The apparatus of any of the preceding examples, further comprising a register containing fields identifying supported history sizes across the plurality of compress cores and the plurality of decompress cores.

Example 8. The apparatus of any of the preceding examples, wherein the plurality of compress cores includes a smallest size compress core configured to use a smallest size history buffer that is equal to or smaller than the size of a history buffer used by other compress cores, and wherein a base engine is configured to receive or read a decompress descriptor identifying a compressed data stream to be decompressed and including an automatic size indicator, and assign decompression operations for the compressed data stream to a decompress core configured to use a history size that is the same as the smallest size compress core.

Example 9. The apparatus of any of the preceding examples, wherein a base engine is configured to receive or read a decompress descriptor identifying a compressed data stream to be decompressed and including an automatic performance indicator, and assign decompression operations for the compressed data stream to a first decompress core.

Example 10. A method implemented on an apparatus including a plurality of compress cores, a plurality of decompress cores supporting a first history size, and a plurality of decompress cores supporting a second history size, comprising receiving or reading a decompression descriptor for decompressing compressed data, and determining, based on data in the decompression descriptor, whether to assign decompression operations to decompress the data to a decompress core supporting the first history size or a decompress core supporting the second history size.

Example 11. The method of example 10, further comprising determining a history size used for the compressed data, and when it is determined the history size is less than or equal to the first history size, assigning decompression of the compressed data to a first decompress core if one is available; otherwise, assigning decompression of the compressed data stream to a second decompress core.

Example 12. The method of example 10 or 11, wherein the plurality of compress cores includes a smallest size compress core configured to use a smallest size history buffer that is equal to or smaller than the size of a history buffer used by other compress cores, further comprising detecting the decompression descriptor includes an automatic size indicator, and assigning decompression operations for the compressed data to a decompress core configured to use a history size that is the same as the smallest size compress core.

Example 13. The method of any of examples 10-12, further comprising detecting the decompression descriptor includes an automatic performance indicator, and assigning decompression operations for the compressed data to a first decompress core.

Example 14. The method of any of examples 10-13, further comprising determining, from data in the decompression descriptor, a third history size used to compress the compressed data, assigning decompression operations to a decompress core having a history size that is larger than the third history size, and operating the decompress core that is assigned to use the third history size.

Example 15. An apparatus, comprising a plurality of processor cores, an interconnect fabric, communicatively coupled to the plurality of processor cores, a memory controller, communicatively coupled to the interconnect fabric and having one or more memory channels, and a first input-output (IO) interface, communicatively coupled to the interconnect fabric. The apparatus further includes an accelerator complex, including, a second IO interface, communicatively coupled to the first IO interface, a plurality of compress cores, a plurality of decompress cores, including, first decompress cores, configured to perform decompression operations using a history buffer having a first size, and a plurality of second decompress cores, configured to perform decompression operations using a history buffer having a second size larger than the first size. The accelerator complex also includes routing and arbitration circuitry to assign compression operations to compression cores, and assign decompression operations to the first decompress cores and the second decompress cores.

Example 16. The apparatus of example 15, wherein the apparatus comprises a System on a Chip (SoC) and wherein the accelerator complex comprises an on-chip accelerator.

Example 17. The apparatus of example 15 or 16, where the accelerator complex further includes a second memory controller having one or more memory channels.

Example 18. The apparatus of any of examples 15-17, wherein the circuitry is further configured to determine a history size used for compressing a compressed data stream to be decompressed, and when it is determined the history size is less than or equal to the first history size, assign decompression of the compressed data stream to a first decompress core if one is available; otherwise, assign decompression of the compressed data stream to a second decompress core.

Example 19. The apparatus of any of examples 15-18, wherein the plurality of compress cores includes a smallest size compress core configured to use a smallest size history buffer that is equal to or smaller than the size of a history buffer used by other compress cores, and wherein the circuitry and logic are further configured to detect a decompression descriptor includes an automatic size indicator; and assign decompression operations for the compressed data to a decompress core configured to use a history size that is the same as the smallest size compress core.

Example 20. The apparatus of any of examples 15-19, wherein the circuitry is further configured to detect a decompression descriptor includes an automatic performance indicator; and assign decompression operations for the compressed data to a first decompress core.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Capital letters, such as ‘M’ and ‘N’ and italicized letters such as ‘n’, in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding firmware components such as firmware executed by an embedded processor or the like. Thus, embodiments may be used as or to support firmware executed upon some form of processor, processing core, or embedded logic, or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the teachings and principles are described herein for illustrative purposes, various equivalent modifications are possible within the scope of the claims, as those skilled in the relevant art will recognize.

These modifications can be made to the embodiments in light of the above detailed description. The terms used in the following claims should not be construed to limit the claim scope to the specific embodiments disclosed in the specification and the drawings. Rather, the scope of the claims is to be determined entirely by the following claims, which are to be construed in accordance with established doctrines of claim interpretation.

What is claimed is:

1. An apparatus, comprising:
a plurality of compress cores;
a plurality of decompress cores, including,
first decompress cores, configured to perform decompression operations using a history buffer having a first size;
second decompress cores, configured to perform decompression operations using a history buffer having a second size larger than the first size;
routing and arbitration circuitry to,
assign compression operations to compression cores; and
assign decompression operations to the first decompress cores and the second decompress cores.

2. The apparatus of claim 1, wherein the circuitry is further configured to:
determine a history size used for compressing a compressed data stream to be decompressed; and
when it is determined the history size is less than or equal to the first history size,
assign decompression of the compressed data stream to a first decompress core if one is available; otherwise,
assign decompression of the compressed data stream to a second decompress core.

3. The apparatus of claim 1, wherein, for each of at least a portion of the plurality of compress cores the compress core is combined with a decompression core in a respective compress-decompress (CD) block.

4. The apparatus of claim 3, where the compress and decompress cores in a CD block are configured to respectively perform compression and decompression operations using the first history size.

5. The apparatus of claim 1, wherein the compress cores are configured to perform compression operations using the first history size.

6. The apparatus of claim 1, further comprising a plurality of base engines configured to manage data streams for which at least one of compression and decompression is to be performed, wherein the routing and arbitration circuitry and logic is implemented in the plurality of base engines.

7. The apparatus of claim 1, further comprising a register containing fields identifying supported history sizes across the plurality of compress cores and the plurality of decompress cores.

8. The apparatus of claim 1, wherein the plurality of compress cores includes a smallest size compress core configured to use a smallest size history buffer that is equal to or smaller than the size of a history buffer used by other compress cores, and wherein a base engine is configured to:
receive or read a decompress descriptor identifying a compressed data stream to be decompressed and including an automatic size indicator; and
assign decompression operations for the compressed data stream to a decompress core configured to use a history size that is the same as the smallest size compress core.

9. The apparatus of claim 1, wherein a base engine is configured to:
receive or read a decompress descriptor identifying a compressed data stream to be decompressed and including an automatic performance indicator; and
assign decompression operations for the compressed data stream to a first decompress core.

10. A method implemented on an apparatus including a plurality of compress cores, a plurality of decompress cores supporting a first history size, and a plurality of decompress cores supporting a second history size, comprising:
receiving or reading a decompression descriptor for decompressing compressed data; and
determining, based on data in the decompression descriptor, whether to assign decompression operations to decompress the data to a decompress core supporting the first history size or a decompress core supporting the second history size.

11. The method of claim 10, further comprising:
determining a history size used for the compressed data; and
when it is determined the history size is less than or equal to the first history size,
assigning decompression of the compressed data to a first decompress core if one is available; otherwise,
assigning decompression of the compressed data stream to a second decompress core.

12. The method of claim 10, wherein the plurality of compress cores includes a smallest size compress core configured to use a smallest size history buffer that is equal to or smaller than the size of a history buffer used by other compress cores, further comprising:
detecting the decompression descriptor includes an automatic size indicator; and
assigning decompression operations for the compressed data to a decompress core configured to use a history size that is the same as the smallest size compress core.

13. The method of claim 10, further comprising:
detecting the decompression descriptor includes an automatic performance indicator; and
assigning decompression operations for the compressed data to a first decompress core.

14. The method of claim 10, further comprising:
determining, from data in the decompression descriptor, a third history size used to compress the compressed data;
assigning decompression operations to a decompress core having a history size that is larger than the third history size; and
operating the decompress core that is assigned to use the third history size.

15. An apparatus, comprising:
a plurality of processor cores,
an interconnect fabric, communicatively coupled to the plurality of processor cores;
a memory controller, communicatively coupled to the interconnect fabric and having one or more memory channels;
a first input-output (IO) interface, communicatively coupled to the interconnect fabric; and
an accelerator complex, including,
a second IO interface, communicatively coupled to the first IO interface;
a plurality of compress cores;
a plurality of decompress cores, including,
first decompress cores, configured to perform decompression operations using a history buffer having a first size;
a plurality of second decompress cores, configured to perform decompression operations using a history buffer having a second size larger than the first size;
routing and arbitration circuitry to,
assign compression operations to compression cores; and
assign decompression operations to the first decompress cores and the second decompress cores.

16. The apparatus of claim 15, wherein the apparatus comprises a System on a Chip (SoC) and wherein the accelerator complex comprises an on-chip accelerator.

17. The apparatus of claim 15, where the accelerator complex further includes a second memory controller having one or more memory channels.

18. The apparatus of claim 15, wherein the circuitry is further configured to:
determine a history size used for compressing a compressed data stream to be decompressed; and
when it is determined the history size is less than or equal to the first history size,
assign decompression of the compressed data stream to a first decompress core if one is available; otherwise,
assign decompression of the compressed data stream to a second decompress core.

19. The apparatus of claim 15, wherein the plurality of compress cores includes a smallest size compress core configured to use a smallest size history buffer that is equal to or smaller than the size of a history buffer used by other compress cores, and wherein the circuitry and logic are further configured to:
detect a decompression descriptor includes an automatic size indicator; and
assign decompression operations for the compressed data to a decompress core configured to use a history size that is the same as the smallest size compress core.

20. The apparatus of claim 15, wherein the circuitry is further configured to:
detect a decompression descriptor includes an automatic performance indicator; and
assign decompression operations for the compressed data to a first decompress core.
